(19) United States
(12) Patent Application Publication
(10) Pub. No.: US 2020/0056471 A1
(43) Pub. Date: Feb. 20, 2020

(54) SYSTEMS AND METHODS OF CONDUCTING SUBTERRANEAN DRILLING OPERATIONS

(71) Applicant: NABORS DRILLING TECHNOLOGIES USA, INC., Houston, TX (US)

(72) Inventors: Brian ELLIS, Spring, TX (US); Danny SPENCER, Houston, TX (US); Kevin ROMEY, Lafayette, LA (US); Jeremy WHITT, Spring, TX (US)

(21) Appl. No.: 16/541,606

(22) Filed: Aug. 15, 2019

Related U.S. Application Data
(60) Provisional application No. 62/719,203, filed on Aug. 17, 2018.

(51) Int. Cl. E21B 44/06; G01N 30/86; E21B 49/08

(52) U.S. Cl. CPC E21B 44/06; E21B 49/081; G01N 30/8675

(57) ABSTRACT

A system for conducting subterranean drilling operations comprising a chromatography device adapted to detect a composition of gas; a sensor adapted to measure a mass flowrate of the gas; and a logic device adapted to calculate volumetric mass flow rates of components of the gas utilizing the mass flowrate from the sensor and the composition from the chromatography device.

### CROSS-REFERENCE TO RELATED APPLICATION

This application claims priority under 35 U.S.C. § 119(e) to U.S. Provisional Patent Application No. 62/719,203 entitled “Systems and Methods of Conducting Subterranean Drilling Operations,” by Brian Ellis et al., filed Aug. 17, 2018, which is assigned to the current assignee hereof and incorporated herein by reference in its entirety.

### FIELD OF THE DISCLOSURE

The present disclosure relates to systems and methods of conducting subterranean drilling operations, and more particularly to systems and methods of analyzing components of gas during drilling operations.

### RELATED ART

Drilling operations in subterranean formations typically involves removal of cuttings from the subterranean formation and circulation thereof to the surface. The cuttings are carried to the surface by drilling fluid and can include gases, vapors, hydrocarbons, and other materials from within the subterranean formation. The drilling industry continues to demand improvements in drilling operations and efficiencies. As such, improvement in qualitative analysis of the drilling fluid is continuously demanded by the industry.

### BRIEF DESCRIPTION OF THE DRAWINGS

Embodiments are illustrated by way of example and are not limited in the accompanying figures.

FIG. 1 includes a schematic view of a system in accordance with an embodiment.

FIG. 2 includes a schematic view of a system in accordance with another embodiment.

FIG. 3 includes a schematic view of a detection area of a system in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

As used herein, “generally equal,” “generally same,” and the like refer to deviations of no greater than 10%, or no greater than 8%, or no greater than 6%, or no greater than 4%, or no greater than 2% of a chosen value. For more than two values, the deviation can be measured with respect to a central value. For example, “generally equal” refer to two or more conditions that are no greater than 10% different in value. Demonstratively, angles offset from one another by 98% are generally perpendicular.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the drilling arts.

Generally, a system for conducting a subterranean drilling operation can include a chromatography device adapted to detect a composition of a gas in the drilling operation. For example, in drilling operations a drill string is lowered into a wellbore and advanced into a subterranean formation. Gases, vapors, and other compositions of material are removed from the subterranean formation and can circulate to the surface of the wellbore where the chromatography device can measure the composition of the gas.

In a particular embodiment, the chromatography device can be disposed in series with a flare line extending from a separating device, such as for example, a mud gas separator or a shaker, to a flare for burn off. In another embodiment, the chromatography device can be disposed in parallel with the flare line.

The chromatography device can include, for example, a thermal conductivity detector (TCD), a flame ionization detector (FID), a quantum cascade laser, or any combination thereof.

A sensor can be adapted to measure a mass flowrate of the gas. In an embodiment, the sensor can be disposed along the flare line. In a more particular embodiment, the sensor can be disposed along the flare line at a location near the chromatography device. In yet a more particular embodiment, the sensor can be disposed upstream of the chromatography device.

In certain embodiments, the sensor can include a photon laser flow meter, an ultrasonic flow meter, an optical flow meter, or any combination thereof.

A logic device, such as for example a microprocessor, can be adapted to calculate volumetric mass flowrate of components of the gas. In an embodiment, the logic device can utilize the mass flowrate measured by the sensor in calculating volumetric mass flowrate. In another embodiment, the logic device can utilize the composition of the gas from the chromatography device in calculating volumetric mass flowrate. In yet a further embodiment, the logic device can utilize the mass flowrate measured by the sensor and the composition of the gas from the chromatography device in calculating volumetric mass flowrate.

A user interface, such as for example a display, can be coupled with the logic device and adapted to display information regarding the calculated volumetric mass flowrate to a user, such as a driller. Such information may be useful in wellbore control, predictive modeling, wellbore plan adjustments, or the like.

A method for conducting subterranean drilling operations can include detecting a composition of gas, sensing a mass flowrate of the gas, and calculating a volumetric flow rate of components of the gas using at least one of the detected composition of the gas and the mass flowrate of the gas.

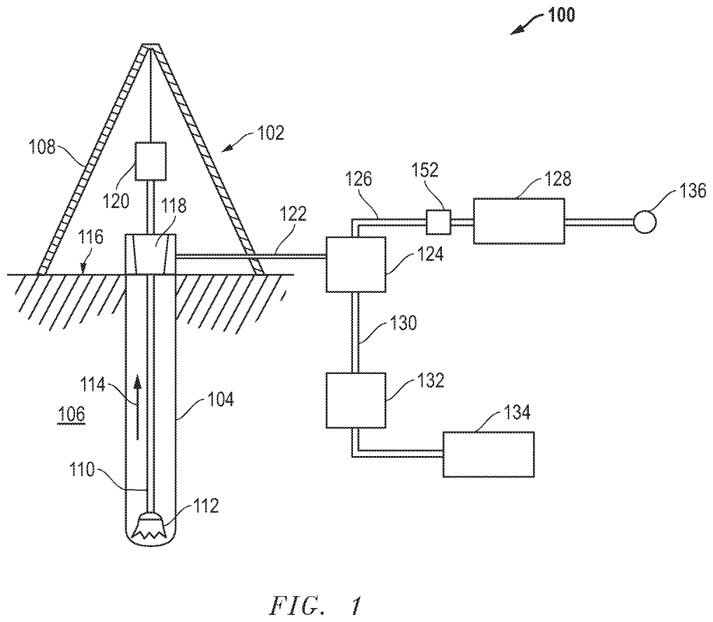

FIG. 1 illustrates an embodiment of a system 100 for conducting subterranean operations including a drill rig 102 disposed above a wellbore 104 extending into a subterranean formation 106. The drill rig 102 can include a mast 108 and a drill rig floor (not illustrated) disposed above the wellbore 104 and adapted to support a drill string 110 extending into the wellbore 104. A bottom hole assembly (BHA) 112 can be disposed at or adjacent to a lower terminal end of the drill string 110. In an embodiment, the BHA 112 can include a drill bit adapted to advance into the subterranean formation 106.

As the BHA 112 advances into the subterranean formation 106, cuttings, gases, vapors, and other materials utilized in drilling, including drilling mud, are circulated through the wellbore 104 in a direction which can generally occur along arrow 114. In a particular embodiment, circulation can be driven at least in part by wellbore pressure management. For example, the drill rig 102 can include mud pumps (not illustrated) adapted to deliver drilling mud into the wellbore 104 to the BHA 112. Pressurized drilling mud can then carry the circulated materials from the BHA 112 location to a surface 116 of the wellbore 104. As the wellbore 104 advances deeper into the subterranean formation 104, the distance of travel between the BHA 112 and the surface 116 of the wellbore 104 can increase.

A rotating control device (RCD) 118 or the like can be disposed at the surface 116 of the wellbore 104. In an embodiment, the RCD 118 can control or assist in controlling pressure within the wellbore. The RCD 118 can form a seal with the wellbore 104, containing hydrocarbons, and other circulating materials within the wellbore 104 and preventing release thereof into the atmosphere or uncontrolled above-surface 116 environment.

A drive unit, such as a top drive 120, can control the drill string's 110 advance into the wellbore 104. During periods of drilling, the top drive 120 (or other known drive unit) can advance the drill string 110 into the wellbore 104.

A flow line 122 extending from the wellbore 104, RCD 118, other intermediary terminal, or a combination thereof can carry flow of wellbore fluid (including for example the drilling mud, cuttings, gases, and vapors) to a separating device 124 adapted to separate at least gases from the wellbore fluid. In an embodiment, the separating device 124 can include a mud gas separator. In a particular embodiment, the mud gas separator can include a plurality of baffles adapted to agitate the wellbore fluid and release gas therefrom. In another embodiment, the separating device 124 can include a shaker having an active agitating mechanism such as a stirrer, to separate gas from the wellbore fluid.

Gas released from the wellbore fluid can travel along a flow line 126 (sometimes referred to as a flare line) to a detection area 128 for analyzation while solids and other non-gases in the wellbore fluid can pass through a flow line 130 to a further separating device 132 which can empty into a mud storage area 134 or directly to the mud storage area 134. Gas can pass through the flow line 126 to the detection area 128 on its way to a flare 136 for burn off. In the illustrated embodiment, the detection area 128 is in series with the flare 136.

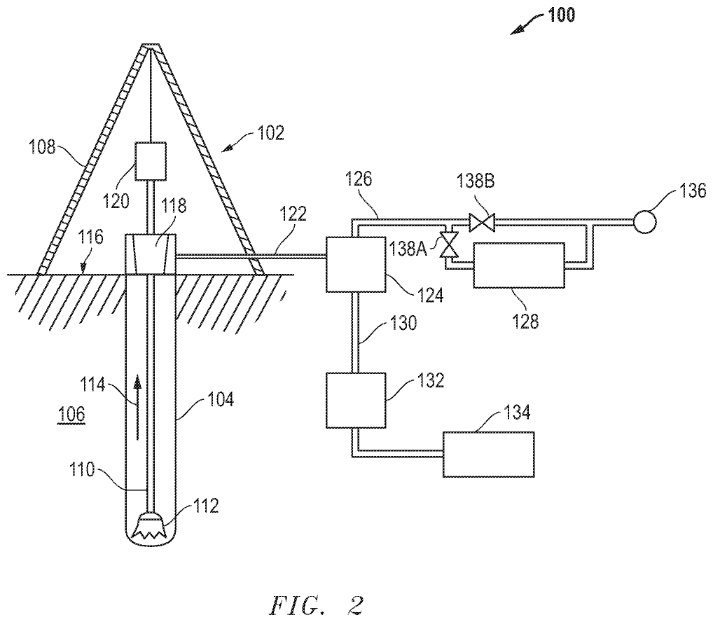

In the embodiment illustrated in FIG. 2, the detection area 128 can be in parallel with the flare 136. One or more valves 138A and 138B can be disposed relative to the flow line 126 and detection area 128 to permit selective fluid flow travel between the separating device 124 and the detection area 128 and flare 136. The one or more valves 138A and 138B can be utilized in the open, partially open, or closed states to selectively pass gas to the detection area 128 and flare 136. It should be understood that the system 100 can include other valves or regulating devices such as chokes adapted to control fluid flow through the system 100. In a particular embodiment, the detection area 128 can be coupled to the flare 136 by an auxiliary flow line 140. In a non-illustrated embodiment, the detection area 128 can be coupled to a separate flare spaced apart or distinct from flare 136.

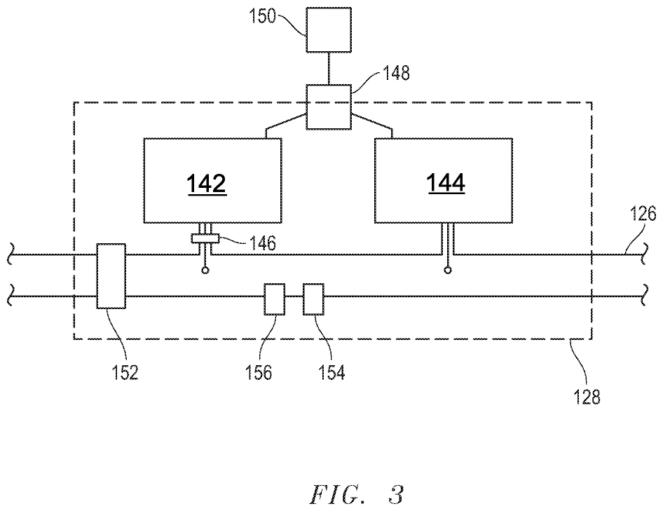

FIG. 3 illustrates an embodiment of the detection area 128 including a portion of the flow line 126 extending therethrough. In an embodiment, the system 100 can be adapted to be retrofit onto an existing drill rig 102. In a more particular embodiment, the detection area 128 of the system 100 can be adapted to be retrofit onto an existing drill rig 102. For example, in an embodiment, the system 100 or the detection area 128 can be portable, such as for example mounted on one or more skids, and delivered to the drill site. The system 100 or detection area 128 can be installed along an existing flow line 126 or otherwise tied into the existing drill rig 102 operation.

In an embodiment, the detection area 128 can include a chromatography device 142 and a sensor 144.

The chromatography device 142 can include, for example, a thermal conductivity detector (TCD), a flame ionization detector (FID), a quantum cascade laser, or a combination thereof. In an embodiment, the chromatography device 142 can include a portion extending into the flow line 126. In another embodiment, the chromatography device 142 can be coupled with the flow line 126 and receive fluid flow from the flow line 126.

In an embodiment, the system 100 can include a pump 146 disposed between the separating device 124 and the chromatography device 142. The pump 146 can be adapted to bias gas to the chromatography device 142. In the illustrated embodiment, the pump 146 is disposed on an auxiliary line between the flow line 126 and the chromatography device 142. In another embodiment, the pump 146 can be disposed along the flow line 126. In yet another embodiment, the chromatography device 142 can be disposed between the pump 146 and the flow line 126.

In an embodiment, the chromatography device 142 can be adapted to detect a composition of a majority, or all, gas passing through the flow line 126. In a specific embodiment, the chromatography device 142 can be adapted to determine the presence of gases passing through the flow line 126. More specifically, the chromatography device 142 can determine which gases are present in the flow line 126.

In a particular embodiment, the chromatography device 142 can be adapted to analyze a sample of the gases in the flow line 126. For example, the chromatography device 142 can be adapted to analyze a sample corresponding with less than 50% of the volume of gas in the flow line 126, less than 40% of the volume of gas in the flow line 126, less than 30% of the volume of gas in the flow line 126, less than 20% of the volume of gas in the flow line 126, less than 10% of the volume of gas in the flow line 126, or less than 5% of the volume of gas in the flow line 126.

The sensor 144 can be coupled with the flow line 126. In an embodiment, the sensor 144 can include a photon laser flow meter, an ultrasonic flow meter, an optical flow meter, or any combination thereof. In an embodiment, the sensor 144 can include a portion extending into the flow line 126. In another embodiment, the sensor 144 can be coupled with the flow line 126 and adapted to receive fluid flow from the flow line 126. In an embodiment, the sensor 144 can be adapted to measure a volumetric flow rate of gas in the flow line 126. In another embodiment, the sensor 144 can be adapted to measure a density of gas in the flow line 126. In yet a further embodiment, the sensor 144 can be adapted to measure a temperature of gas in the flow line 126. In yet another embodiment, the sensor 144 can be adapted to measure any combination of volumetric flow rate, density, and temperature of gas in the flow line 126.

In an embodiment, the chromatography device 142 and sensor 144 can be coupled with a logic device 148, such as a microprocessor, adapted to calculate volumetric flow rate of components of the gas. The chromatography device 142 can send detected composition of gas to the logic device 148. The sensor 144 can send, for example, sensed characteristics of the flowrate of the gas to the logic device 148. In an embodiment, the logic device 148 can utilize the sensed characteristics of the gas to calculate volumetric flow rates of components of the gas, mass flow rates of components of the gas, or a combination thereof.

Volumetric flow rates of components of the gas can include calculated volumetric flow rates of individual components of the gas. Thus, for example, the logic device 148 can determine individual volumetric flow rates or mass flow rates of each gas exiting the wellbore 104. In such a manner, the logic device 148 can provide quantitative gas analysis previously unavailable or lacking during drilling operations.

In an embodiment, the logic device 148 can be disposed within the detection area 128 of the system 100. For example, the logic device 148 can be attached to the portable detection area 128, such as on the skid (not illustrated). In another embodiment, the logic device 148 can be spaced apart from the detection area 128 such as at a different location than the chromatography device 142 and the sensor 144. For example, the logic device 148 can be disposed in a controlled environment, such as a laboratory or analysis area not at the drill site. In another embodiment, the logic device 148 can be disposed in an operating area of the drill rig 102. In a particular embodiment, the logic device 148 can be retrofit in the operating system of the drill rig 102. For example, the logic device 148 can be coupled with or programmed into the operating system of the drill rig 102.

In an embodiment, the logic device 148 can be remotely coupled with at least one of the chromatography device 142 and the sensor 144. In a more particular embodiment, the logic device 148 can be remotely coupled with the chromatography device 142 and the sensor 144. For example, the logic device 148 can be coupled to at least one of the chromatography device 142 and sensor 144 by way of a wireless protocol, such as a wireless network, satellite, HTTP, or mobile telephone based operating protocol. In another embodiment, the logic device 148 can be coupled to at least one of the chromatography device 142 and sensor 144 by a wired protocol, such as a local Ethernet or other wired system.

In an embodiment, the logic device 148 can be in communication with a display apparatus 150 adapted to remotely display the volumetric mass flow rates of the components of the gas. In a particular embodiment, the display apparatus 150 can be disposed within the detection area 128. For example, the display apparatus 150 can be disposed on the skid (not illustrated) for on-site viewing. The display apparatus 150 can be disposed on the drill rig 102 or within an operating area of the drill rig 102. The display apparatus 150 can be disposed at a remote location spaced apart from the drill site. The display apparatus 150 can be in communication with the logic device 148 by way of a wireless protocol or a wired protocol.

The user, such as a driller, can view the display apparatus 150 to determine composition of the subterranean formation 106 (FIG. 1). More particularly, the user can view the display apparatus 150 to determine the gas composition of the subterranean formation 106. The user can adjust one or more drilling parameters such as for example fluid flow rate within the wellbore, drilling angle or operation of the BHA 112, speed or torque of the top drive 120, or any combination thereof in response to the composition of gases in the subterranean formation 106. In such a manner, the user can take action to control the wellbore, increase drilling efficiency, alter the wellbore plan, or otherwise adjust the wellbore in a desired manner. For example, when drilling certain subterranean formations 106, the presence of certain gases at certain volumetric ratios can indicate a specific action should be taken by the driller. Through detailed analysis provided by the system 100, the driller can better predict and control the drilling operation. Further, the driller can identify different zones of the subterranean formation, such as fracking zones, based on the presence of certain gases at certain volumetric ratios.

In certain embodiments, the logic device 148 can be coupled with, or part of, an autonomous system adapted to adjust one or more parameters of the wellbore in response to the volumetric mass flowrate of components of the gases from the wellbore 104. For example, the autonomous system can be preprogrammed or taught to recognize conditions of the wellbore 104 or subterranean formation 106 based on volumetric flowrates of components of the gases therefrom. Once the autonomous system detects thresholds of volumetric flowrate outside of operating limits, the system can adjust one or more parameters of the wellbore 104 for desired drilling efficiency, safety, or a combination thereof.

Referring again to FIG. 1, in certain instances, the system 100 can include a gas dryer 152 disposed between the separating device 124 and the detection area 128, such as between the separating device 124 and the chromatography device 142. The gas dryer 152 can be disposed, for example, along flow line 126. The gas dryer 152 can dry the gas and components thereof to enhance detection and measurement thereof and to increase accuracy. In an embodiment, the gas dryer 152 can remove undesired liquid vapors or particles which may have escaped the agitating device 124 through the flow line 126. In certain instances, removal of such vapors or particles can enhance detectability of gas components, increase operational life expectancy of the system 100, or increase detection and analytical accuracy.

As illustrated in FIG. 3, in an embodiment the system 100 can include a gas filtration system 152, a gas density sensor 154, a temperature sensor 156, or any combination thereof. In non-illustrated embodiments, the system 100 can further include an automated cuttings cleaning and lithology logging system optionally including XFR camera logging. In a particular embodiment, the gas filtration system 152 can be disposed between the separating device 124 and the gas density sensor 154, sensor 144, or both. In an embodiment, the gas density sensor 154, temperature sensor 156, or a combination thereof can be distinct from the sensor 144. In another embodiment, the gas density sensor 154, temperature sensor 156, CDT mud sensor system 158, or a combination thereof can be the same or part of sensor 144.

In certain instances, a driller may desire to understand the wellbore fluid, and more particularly the composition of gas in the wellbore fluid, as it relates to the depth of capture. That is, the driller may desire correlating the analyzed volumetric mass flow rates of components of the gas to the actual depth from which the gas was removed from. However, given lag time associated with wellbore fluid movement, wellbore depth, and time required for analysis of the gas, it may be necessary to adjust the volumetric flow rate of the components of the gas to correspond with the depth from which the gas resided in the subterranean formation 106. In an embodiment, the logic device 148, or another logic device, can be adapted to provide the volumetric flow rate of the components of the gas at the depth or location, or approximate depth or approximate location, where the gas resided in a subterranean formation 106. In such a manner, wellbore fluid analyzed in the detection area 128 can be linked with the depth or location, or approximate depth or approximate location, where the gas resided in the subterranean formation 106. In an embodiment, calibrated information relating the gas composition to the depth of extraction can be displayed to the driller on the user interface 150. Similarly, such calibration can be used by an autonomous system (previously described) to affect a change in wellbore parameters.

Skilled artisans will understand after reading the entire disclosure that certain embodiments described herein can offer quantitative analysis of the wellbore condition. Such quantitative analysis has been lacking in the drilling industry and is required today for advanced drilling techniques in dangerous and hostile drilling environments where even small deviations can result in economic or efficiency losses. Moreover, simply detecting the presence of gases without quantitatively analyzing such gases is insufficient for modern equipment and processes capable of advanced adaptation to advanced wellbore monitoring conditions.

The present invention has broad applicability and can provide many benefits as described and shown in the examples above. The embodiments will vary greatly depending upon the specific application, and not every embodiment will provide all of the benefits and meet all of the objectives that are achievable by the invention. Note that not all of the activities described above in the general description or the examples are required, that a portion of a specific activity may not be required, and that one or more further activities may be performed in addition to those described. Still further, the order in which activities are listed are not necessarily the order in which they are performed.

Embodiments of the present invention are described generally herein in relation to drilling directional wells or unconventional wells, but it should be understood, however, that the methods and the apparatuses described may be equally applicable to other drilling environments. Further, while the descriptions and figures herein show a land-based drilling rig, one or more aspects of the present disclosure are applicable or readily adaptable to any type of drilling rig, such as jack- up rigs, semisubmersibles, drill ships, coil tubing rigs, well service rigs adapted for drilling and/or re-entry operations, and casing drilling rigs, among others within the scope of the present disclosure.

Embodiment 1. A system for conducting subterranean drilling operations comprising: a chromatography device adapted to detect a composition of gas; a sensor adapted to measure a mass flowrate of the gas; and a logic device adapted to calculate volumetric mass flow rates of components of the gas utilizing the mass flowrate from the sensor and the composition from the chromatography device.

Embodiment 2. The system of embodiment 1, wherein the system is adapted to be retrofit onto an existing drilling rig.

Embodiment 3. The system of embodiment 1, wherein the system further comprising: a gas dryer disposed between the mud gas separator and the chromatography device.

Embodiment 4. The system of embodiment 1, wherein at least the chromatography device is disposed in series with a flare line or disposed in parallel with the flare line.

Embodiment 5. The system of embodiment 1, wherein the logic device is in communication with a display apparatus adapted to remotely display the volumetric mass flowrates of the components of the gas.

Embodiment 6. The system of embodiment 1, wherein the logic device is adapted to provide the volumetric mass flowrate of the components of the gas at an approximate depth or an approximate location where the gas was extracted from the subterranean formation.

Embodiment 7. The system of embodiment 1, wherein the sensor comprises a photon laser flow meter, an ultrasonic flow meter, an optical flow meter, or any combination thereof.

Embodiment 8. The system of embodiment 1, further comprising: a pump disposed between a mud gas separator and the chromatography device, wherein the pump is adapted to bias gas to the chromatography device.

Embodiment 9. The system of embodiment 1, further comprising: a gas filtration system.

Embodiment 10. The system of embodiment 9, further comprising: a gas density sensor.

Embodiment 11. The system of embodiment 10, wherein the gas filtration system is disposed between a mud gas separator and the gas density sensor.

Embodiment 12. The system of embodiment 1, further comprising: a temperature sensor.

Embodiment 13. The system of embodiment 1, further comprising: a CDT mud sensor system.

Embodiment 14. The system of embodiment 1, wherein the sensor is adapted to measure a volumetric flow rate, a density of the gas, a temperature of the gas, or a combination thereof.

Embodiment 15. The system of embodiment 1, wherein the chromatography device comprises a thermal conductivity detector (TCD), a flame ionization detector (FID), a quantum cascade laser, or a combination thereof.

Embodiment 16. The system of embodiment 1, wherein the system is adapted to provide a quantitative analysis of the composition of gas.

Embodiment 17. A method for conducting subterranean drilling operations comprising: detecting a composition of a gas; sensing a mass flowrate of the gas; calculating volumetric mass flowrates of a plurality of components of the gas using the detected composition of the gas and the mass flowrate of the gas.

Embodiment 18. The method of embodiment 17, wherein detecting the composition of the gas is performed by a chromatography device.

Embodiment 19. The method of embodiment 18, wherein the chromatography device is disposed in series with a flare line or disposed in parallel with the flare line.

Embodiment 20. The method of embodiment 18, wherein the chromatography device is adapted to analyze a sample of the gas exiting a mud gas separator.

Embodiment 21. The method of embodiment 20, wherein the sample of gas comprises less than 50% of the volume of gas exiting the mud gas separator, less than 40% of the volume of gas exiting the mud gas separator, less than 30% of the volume of gas exiting the mud gas separator, less than 20% of the volume of gas exiting the mud gas separator, less than 10% of the volume of gas exiting the mud gas separator, or less than 5% of the volume of gas exiting the mud gas separator.

Embodiment 22. The method of embodiment 18, further comprising: biasing the gas from a mud gas separator to the chromatography device using a pump.

Embodiment 23. The method of embodiment 17, wherein sensing mass flowrate is performed by a sensor, and wherein the sensor comprises a photon laser flowrate sensor.

Embodiment 24. The method of embodiment 23, wherein the sensor is disposed in series with the flare line or disposed in parallel with the flare line.

Embodiment 25. The method of embodiment 17, further comprising: retrofitting the components to an existing drilling rig.

Embodiment 26. The method of embodiment 25, wherein retrofitting the components to the existing drilling rig is performed by coupling the components with a flare line of the drilling rig.

Embodiment 27. The method of embodiment 17, wherein calculating volumetric mass flowrates is performed by a logic device.

Embodiment 28. The method of embodiment 17, further comprising: drying the gas prior to detecting the composition thereof.

Embodiment 29. The method of embodiment 28, wherein drying is performed by a gas drying device.

Embodiment 30. The method of embodiment 17, further comprising: linking the detected composition of the gas to an approximate location or an approximate depth where the gas resided in a subterranean formation.

Embodiment 31. The method of embodiment 30, wherein linking the detected composition is performed by a logic device.

Embodiment 32. The method of embodiment 17, further comprising: adjusting a wellbore parameter in response to the calculated volumetric mass flowrates of components of the gas.

Embodiment 33. The method of embodiment 32, wherein adjusting the wellbore parameter comprises adjusting a direction of a tool face orientation associated with a bottom hole assembly, adjusting a wellbore pressure, adjusting an input torque to a drill string, adjusting an input speed to the drill string, or any combination thereof.

Embodiment 34. The method of embodiment 17, wherein detecting is performed by a chromatography device, wherein sensing is performed by a sensor.

Embodiment 35. The method of embodiment 34, wherein the chromatography device and sensor are disposed on a portable element, the system further comprising: installing the portable element prior to detecting the composition of the gas.

Embodiment 36. The method of embodiment 35, wherein installing the portable element comprises introducing at least one of the chromatography device and sensor to a flare line of the drill rig.

Embodiment 37. The method of embodiment 17, wherein calculating volumetric mass flowrates of components of the gas comprises: inputting into a logic device the composition of the gas; inputting into the logic device the mass flowrate of the gas; and calculating the volumetric mass flowrate of each component of the composition of gas.

Embodiment 38. The method of embodiment 37, further comprising: displaying the calculated volumetric mass flow rate of each component of the composition of gas to a user.

Embodiment 39. The method of embodiment 37, further comprising: inputting into the logic device a volumetric flowrate of the composition of the gas.

Embodiment 40. The method of embodiment 17, wherein calculating volumetric mass flowrates of components of the gas comprises calculating volumetric mass flowrates of all components of the gas.

Embodiment 41. The method of embodiment 17, wherein calculating volumetric mass flowrates of components of the gas comprises calculating volumetric mass flowrates of at least two different gas components, at least three different gas components, at least five different gas components, at least ten different gas components, at least twenty different gas components, at least fifty different gas components, or at least one hundred different gas components.

Embodiment 42. The method of embodiment 41, wherein each different gas component comprises a unique chemical composition.

Embodiment 43. A system for conducting subterranean drilling operations comprising: a logic device adapted to calculate volumetric mass flow rates of components of a gas from a wellbore; and at least one of: a user display adapted to display the calculated volumetric mass flow rate to a user; an autonomous system adapted to autonomously adjust a parameter of a wellbore condition in response to the calculated volumetric mass flow rate; or a combination thereof.

Embodiment 44. The system of embodiment 43, wherein the logic device is adapted to provide an approximate location or an approximate depth of the calculated volumetric mass flow rate.

Embodiment 45. The system of embodiment 43, wherein the calculated volumetric flow rate is quantitatively expressive of the components of gas from the wellbore.

Embodiment 46. The system of embodiment 43, wherein the logic device is adapted to receive a composition of the gas and a volumetric flowrate of the gas, and wherein the devices adapted to determine the composition and volumetric flowrate of the gas are disposed on a portable element adapted to be retrofit into an existing drill rig.

Embodiment 47. The system of embodiment 43, wherein the logic device is adapted to map the components of the gas as a function of approximate depth or approximate location of the components of the gas relative to the wellbore.

1. A method for conducting subterranean drilling operations comprising:
detecting a composition of a gas;
sensing a mass flowrate of the gas; and
calculating volumetric mass flowrates of a plurality of components of the gas using the detected composition of the gas and the mass flowrate of the gas.

2. The method of claim 1, wherein detecting the composition of the gas is performed by a chromatography device.

3. The method of claim 2, wherein the chromatography device is adapted to analyze a sample of the gas exiting a mud gas separator.

4. The method of claim 3, further comprising: biasing the gas from the mud gas separator to the chromatography device using a pump.

5. The method of claim 4, wherein the sample of gas comprises less than 50% of the volume of gas exiting the mud gas separator, less than 40% of the volume of gas exiting the mud gas separator, less than 30% of the volume of gas exiting the mud gas separator, less than 20% of the volume of gas exiting the mud gas separator, less than 10% of the volume of gas exiting the mud gas separator, or less than 5% of the volume of gas exiting the mud gas separator.

6. The method of claim 1, wherein sensing the mass flowrate is performed by a sensor, and wherein the sensor comprises a photon laser flowrate sensor.

7. The method of claim 1, further comprising: retrofitting the components to an existing drilling rig.

8. The method of claim 7, wherein retrofitting the components to the existing drilling rig is performed by coupling the components with a flare line of the drilling rig.

9. The method of claim 1, wherein calculating volumetric mass flowrates is performed by a logic device.

10. The method of claim 1, further comprising: drying the gas prior to detecting the composition thereof.

11. The method of claim 1, further comprising: linking the detected composition of the gas to an approximate location or an approximate depth where the gas resided in a subterranean formation.

12. The method of claim 11, wherein linking the detected composition is performed by a logic device.

13. The method of claim 1, further comprising: adjusting a wellbore parameter in response to the calculated volumetric mass flowrates of components of the gas.

14. The method of claim 13, wherein adjusting the wellbore parameter comprises adjusting a direction of a tool face orientation associated with a bottom hole assembly, adjusting a wellbore pressure, adjusting an input torque to a drill string, adjusting an input speed to the drill string, or any combination thereof.

15. The method of claim 1, wherein detecting the composition of the gas is performed by a chromatography device, wherein sensing the mass flowrate of the gas is performed by a sensor, and wherein the chromatography device and sensor are disposed on a portable element, the method further comprising: installing the portable element prior to detecting the composition of the gas.

16. The method of claim 15, wherein installing the portable element comprises introducing at least one of the chromatography device and sensor to a flare line of the drill rig.

17. The method of claim 1, wherein calculating the volumetric mass flowrates of components of the gas comprises:
inputting into a logic device the composition of the gas;
inputting into the logic device the mass flowrate of the gas; and
calculating the volumetric mass flowrate of each component of the composition of gas.

18. The method of claim 17, further comprising: displaying the calculated volumetric mass flow rate of each component of the composition of gas to a user.

19. The method of claim 1, wherein calculating the volumetric mass flowrates of components of the gas comprises calculating volumetric mass flowrates of all components of the gas.

20. The method of claim 19, wherein calculating the volumetric mass flowrates of components of the gas comprises calculating volumetric mass flowrates of at least two different gas components, at least three different gas components, at least five different gas components, at least ten different gas components, at least twenty different gas components, at least fifty different gas components, or at least one hundred different gas components, and wherein each different gas component comprises a unique chemical composition.
